(19) United States
(12) Patent Application Publication
(10) Pub. No.: US 2026/0303343 A1
(43) Pub. Date: Oct. 1, 2026

(54) CRYPTOGRAPHIC SERVICE PROVIDER API WITH NON-NATIVE KEY EMULATION

(71) Applicant: INTERNATIONAL BUSINESS MACHINES CORPORATION, ARMONK, NY (US)

(72) Inventors: MICHAEL JOSEPH JORDAN, WOODSTOCK, NY (US); TAMAS VISEGRADY, ZURICH (CH); JONATHAN D. BRADBURY, POUGHKEEPSIE, NY (US)

(21) Appl. No.: 19/093,378

(22) Filed: Mar. 28, 2025

(51) Int. Cl. H04L 9/08; G06F 9/54

(52) U.S. Cl. CPC H04L 9/0894; G06F 9/547; H04L 9/0861

(57) ABSTRACT

A computer system employs a native cryptographic service provider (CSP) application interface (API) that parses a full cryptographic key token from a non-native CSP API, into a functional key object and a non-functional metadata object. The native CSP API cryptographically links the functional key object and the non-functional metadata object to form a linked object pair representing the full cryptographic key token. In response to a CSP API call, such as a modify key call or a derive key call, the native CSP API generates an updated cryptographically linked object pair by updating at least one of either the cryptographically linked functional key object or the non-functional metadata object of the linked object pair. The native CSP API exports a fully formed modified cryptographic key token based on the updated cryptographically linked object pair.

### BACKGROUND

The present disclosure relates to methods, apparatus, and products for providing cryptographic services.

Cryptographic service providers (CSPs) are service provider modules which perform cryptographic operations including one or more of encryption, decryption, digital signing, key and key pair generation, random number generation (RNG), message digest, key wrapping, key unwrapping, and key exchange. Cryptographic service provider modules and their application interfaces can be implemented by a hardware-software combination, by software only, or by hardware only. Typically, a CSP is made tamper-resistant as part of a hardware security module HSM). Applications, such as financial applications, passport applications and other types of applications call a cryptographic service provider application interface (CSP API) to perform a cryptographic operation that is typically performed by a cryptographic engine in the hardware security module (HSM).

Importing raw objects, such as key tokens, between CSP APIs that use different key formats use existing approaches that rely on transporting raw keys, do not transport attributes, such as those that identify usage restrictions, which are unique to the foreign CSP API that provided the key token to a native CSP API. Instead, key attributes may be dropped. For example, once a non-native (also referred to as foreign) key token has been transported across CSP API boundaries, key attributes are lost and the non-native key cannot be reconstructed in a correct foreign form. If keys have been maliciously imported through a CSP API, such that the non-native keys are separated from their restrictive usage attributes, the non-native keys can be misused once they are again exported by the CSP API.

### SUMMARY

According to embodiments of the present disclosure, various methods, apparatus and products provide a cryptographic service provider (CSP) application interface (API) with non-native key emulation services that improve system security. In some aspects, a 'native' CSP API includes service additions to calls to carry key and key attributes as a functional key object of a full ‘non-native’ cryptographic key token from a 'foreign' CSP API and, non-functional metadata as a non-functional metadata object that are bound as a pair of linked key objects. While the non-functional metadata objects are of no functional use for the native CSP API, the improved CSP API provides secure storage of all foreign CSP API information associated with a non-native key while the non-native key attributes are being modified and/or new keys are being derived from the foreign key by the native CSP API. In some implementations, raw keys of the foreign key token, and their usage restrictions which are understood by the native CSP API, are emulated as regular native-CSP API object pairs in the form of a functional key object and a non-functional metadata object pair. After key operations are done on the foreign key by the CSP API, the key and any modified key attributes are exported along with any updated non-functional metadata to provide an accurate and more secure modified non-native key token that leaves the CSP API boundary.

In some implementations, a computing system, employs one or more processors and one or more computer-readable storage media that has program instructions stored on the one or more storage media to cause the one or more processors to perform certain operations. In some implementations, the operations include parsing, by a first cryptographic service provider (CSP) application interface (API), such as a native CSP API, a full cryptographic key token from a second CSP API, such as a non-native CSP API. The native CSP API parses the full cryptographic key token into a functional key object and a non-functional metadata object. The native CSP API cryptographically links the functional key object and the non-functional metadata object to form a linked object pair representing the full cryptographic key token. The non-functional metadata object contains, for example, human readable data that is inert to the native CSP API. In response to a CSP API call from an application, the native CSP API generates an updated cryptographically linked object pair by updating at least one of either the cryptographically linked functional key object or the non-functional metadata object of the linked object pair. The native CSP API exports a fully formed modified cryptographic key token based on the updated cryptographically linked object pair.

### BRIEF DESCRIPTION OF THE DRAWINGS

FIG. 1 sets forth an example computing environment according to aspects of the present disclosure.

FIG. 2 sets forth an example of a computer system with a cryptographic service provider with non-native key emulation according to aspects of the present disclosure.

FIG. 3 sets forth a block diagram illustrating an example cryptographic service provider (CSP) application interface (API) with non-native key emulation services according to aspects of the present disclosure.

FIG. 4 sets forth a flowchart of a method for providing cryptographic services using a CSP API according to aspects of the present disclosure.

FIG. 5 sets forth a diagram illustrating bound non-native functional key object and associated non-functional metadata object pairs stored in memory according to aspects of the present disclosure.

FIG. 6 sets forth a flowchart of a method for providing cryptographic services using a CSP API according to aspects of the present disclosure.

FIG. 7 sets forth a flowchart of a method for providing cryptographic services using a CSP API according to aspects of the present disclosure.

### DETAILED DESCRIPTION

In some implementations, a computing system, employs one or more processors and one or more computer-readable storage media that has program instructions stored on the one or more storage media to cause the one or more processors to perform certain operations. In some implementations, the operations include parsing, by a first cryptographic service provider (CSP) application interface (API), such as a native CSP API, a full cryptographic key token from a second CSP API, such as a non-native CSP API. The native CSP API parses the full cryptographic key token into a functional key object and a non-functional metadata object. The native CSP API cryptographically links the functional key object and the non-functional metadata object to form a linked object pair representing the full cryptographic key token. The non-functional metadata object contains, for example, human readable data that is inert to the native CSP API. In response to a CSP API call from an application or other source, the native CSP API generates an updated cryptographically linked object pair by updating at least one of either the cryptographically linked functional key object or the non-functional metadata object of the linked object pair. The native CSP API exports a fully formed modified cryptographic key token based on the updated cryptographically linked object pair.

The additional securely maintained metadata associated with functionally usable keys allows the native CSP API to export fully formed non-native objects, even if almost none of the native CSP API understands details of an imported full key token’s 'foreign' attributes making the computing system more secure. The exported foreign keys include the updated non-functional metadata that can indicate changes made to the foreign key’s restrictions or other information to prevent misuse of the key when exported. In some implementations, added functionality to the calls track the simultaneous evolution of keys and attributes, as an overlay to otherwise unchanged API calls.

In certain implementations, a computer-implemented method comprises parsing, by a first cryptographic service provider (CSP) application interface (API), a full cryptographic key token from a second CSP API, into a functional key object and a non-functional metadata object. The CSP API cryptographically links the functional key object and the non-functional metadata object to form a linked object pair representing the full cryptographic key token. In response to a CSP API call, the first CSP API generates an updated cryptographically linked object pair by updating at least one of either the cryptographically linked functional key object or the non-functional metadata object of the linked object pair and exports, a fully formed modified cryptographic key token based on the updated cryptographically linked object pair. The fully formed modified cryptographic key token is in the proper format for the second CSP API or other process. Among many technical effects, the first CSP API serves as a more efficient generic type CSP API that reduces the storage required and processing required for an additional non-native CSP API and provides key modification support for native and non-native CSP APIs.

In certain implementations, the computer-implemented method parses the full cryptographic key token by creating the functional key object to include a key and key attributes obtained from the full cryptographic key token and creates the non-functional metadata object to include CSP API inert data obtained from the full cryptographic key token. In this way the first CSP API efficiently reduces processing time by knowing to ignore the non-functional metadata object when carrying out certain tasks but retaining the non-functional metadata to effectively add back in when the modified keys are exported in their original format.

In certain implementations, the computer-implemented method generates the updated cryptographically linked object pair using a CSP API call that changes a key attribute of the functional key object and changes the data of the non-functional metadata object, and cryptographically binds the functional key object with the non-functional metadata object. A technical effect is a secure binding of non-native data with non-native key data when performing key management operations prior to exporting a modified non-native key from the CSP API.

In some implementations, the computer-implemented method generates the updated cryptographically linked object pair using a CSP API call that generates a functional key object comprising a derived key from the key in the functional key object and that changes data in a corresponding bound non-functional metadata object and cryptographically binds the functional key object with the non-functional metadata object. A technical effect is a cryptographically secure binding of non-native data with non-native key data when performing key management operations prior to exporting a modified non-native key from the CSP API.

In certain implementations, the computer-implemented method generates the updated cryptographically linked object pair in response to the CSP API call by generating a data object entry in memory that comprises the updated cryptographically linked object pair. A technical effect is a cryptographically secure binding of non-native data with non-native key data when performing key management operations prior to exporting a modified non-native key from the CSP API.

In some implementations, the computer-implemented method exports the fully formed foreign cryptographic key token by identifying one of a plurality of updated cryptographically linked object pairs that corresponds to the full cryptographic key token, and cryptographically wraps the identified updated cryptographically linked object pair to form the fully formed foreign cryptographic key token. Among many technical effects, the first CSP API serves as a more efficient generic type CSP API that reduces the storage required and processing required for an additional non-native CSP API and provides key modification support for both native and non-native CSP APIs.

In certain implementations, in response to a call to perform a functional operation using the key and key attributes in the functional key object, the computer-implemented method employs a CSP API that ignores the data in the non-functional metadata object to perform the functional operation. Among many technical effects, the first CSP API serves as a more efficient generic type CSP API that reduces the storage required and processing required for an additional non-native CSP API and provides key modification support for both native and non-native CSP APIs.

In some implementations, a computer system includes one or more processors, one or more computer-readable storage media and program instructions stored on the one or more storage media to cause the one or more processors to perform operations comprising: parsing, by a first cryptographic service provider (CSP) application interface (API), a full cryptographic key token from a second CSP API, into a functional key object and a non-functional metadata object; cryptographically linking the functional key object and the non-functional metadata object to form a linked object pair representing the full cryptographic key token; in response to a CSP API call, generating an updated cryptographically linked object pair by updating at least one of either the cryptographically linked functional key object or the non-functional metadata object of the linked object pair; and exporting, by the first CSP API, a fully formed modified cryptographic key token based on the updated cryptographically linked object pair. Among many technical effects, the first CSP API serves as a more efficient generic type CSP API that reduces the storage required and processing required for an additional non-native CSP API and provides key modification support for native and non-native CSP APIs.

In certain implementations, the computer system comprises a hardware security module (HSM) that comprises the one or more processors and the one or more computer-readable storage media and the program instruction cause the one or more processors to store the linked object pair representing the full cryptographic key token and the updated cryptographically linked object pair in the one or more computer-readable storage media in the HSM. A technical effect is a secure binding of non-native data with non-native key data when performing key management operations by a native CSP API, prior to exporting a modified non-native key from the CSP API.

In some implementations, the computer system includes program instructions stored on the one or more storage media to cause the one or more processors to generate the updated cryptographically linked object pair using a CSP API call that changes a key attribute of the functional key object and changes data of the non-functional metadata object, and cryptographically binds the functional key object with the non-functional metadata object. A technical effect is a secure binding of non-native data with non-native key data when performing key management operations by a native CSP API, prior to exporting a modified non-native key from the CSP API.

In some examples, the computer system employs program instructions stored on the one or more storage media that cause the one or more processors to parse the full cryptographic key token by creating the functional key object to comprise a key and key attributes obtained from the full cryptographic key token and creating the non-functional metadata object to comprise CSP API inert data obtained from the full cryptographic key token. In this way the first CSP API efficiently reduces processing time by knowing to ignore the non-functional metadata object when carrying out certain tasks but retaining the non-functional metadata to effectively add back in when the modified keys are exported in their original format.

In some examples, the computer system employs program instructions stored on the one or more storage media that cause the one or more processors to generate the updated cryptographically linked object pair using a CSP API call that generates a functional key object comprising a derived key from the key in the functional key object and changes data in a corresponding bound non-functional metadata object and cryptographically binds the functional key object with the non-functional metadata object. A technical effect is a secure binding of non-native data with non-native key data when performing key management operations prior to exporting a modified non-native key from the CSP API.

In some implementations, the computer system employs program instructions stored on the one or more storage media the cause the one or more processors to generate the updated cryptographically linked object pair in response to the CSP API call by generating a data object entry in memory that comprises the updated cryptographically linked object pair. A technical effect is a cryptographically secure binding of non-native data with non-native key data when performing key management operations prior to exporting a modified non-native key from the CSP API.

In some examples, the computer system employs program instructions stored on the one or more storage media that cause the one or more processors to export, by the first CSP API, the fully formed modified cryptographic key token by identifying one of a plurality of updated cryptographically linked object pairs that corresponds to the full cryptographic key token, and cryptographically wrapping the identified updated cryptographically linked object pair to form the fully formed modified cryptographic key token. Among many technical effects, the first CSP API serves as a more efficient generic type CSP API that reduces the storage required and processing required for an additional non-native CSP API and provides key modification support for both native and non-native CSP APIs.

In some examples, the computer system employs program instructions stored on the one or more storage media that cause the one or more processors to, in response to a call to perform a functional operation, use the key and key attributes in the functional key object, and ignore the data in the non-functional metadata to perform the functional operation. Among many technical effects, the first CSP API serves as a more efficient generic type CSP API that reduces the storage required and processing required for an additional non-native CSP API and provides key modification support for both native and non-native CSP APIs.

A computer program product comprises one or more computer-readable storage media; and program instructions stored on the one or more storage media to perform operations comprising: parsing, by a first cryptographic service provider (CSP) application interface (API), a full cryptographic key token from a second CSP API, into a functional key object and a non-functional metadata object; cryptographically linking the functional key object and the metadata object to form a linked object pair representing the full cryptographic key token; in response to a CSP API call, generating an updated cryptographically linked object pair by updating at least one of either the cryptographically linked functional key object or the non-functional metadata object of the linked object pair; and exporting, by the first CSP API, a fully formed modified cryptographic key token based on the updated cryptographically linked object pair. Among many technical effects, the first CSP API serves as a more efficient generic type CSP API that reduces the storage required and processing required for an additional non-native CSP API and provides key modification support for both native and non-native CSP APIs.

In some implementations, the computer program product comprises program instructions stored therein to perform operations comprising generating the updated cryptographically linked object pair using a CSP API call that changes a key attribute of the functional key object and changes data of the non-functional metadata object, and cryptographically binds the functional key object with the non-functional metadata object.

In certain implementations, the computer program product comprises program instructions stored therein to perform operations comprising parsing the full cryptographic key token by creating the functional key object to comprise a key and key attributes obtained from the full cryptographic key token and creating the non-functional metadata object to comprise CSP API inert data obtained from the full cryptographic key token.

In some examples, the computer program product comprises program instructions stored therein to perform operations comprising generating the updated cryptographically linked object pair using a CSP API call that generates a functional key object comprising a derived key from the key in the functional key object and changes data in a corresponding bound non-functional metadata object and cryptographically binds the functional key object with the non-functional metadata object.

In some implementations, the computer program product comprises program instructions stored therein to perform operations comprising causing to export, by the first CSP API, the fully formed modified cryptographic key token by identifying one of a plurality of updated cryptographically linked object pairs that corresponds to the full cryptographic key token, and cryptographically wrapping the identified updated cryptographically linked object pair to form the fully formed modified cryptographic key token.

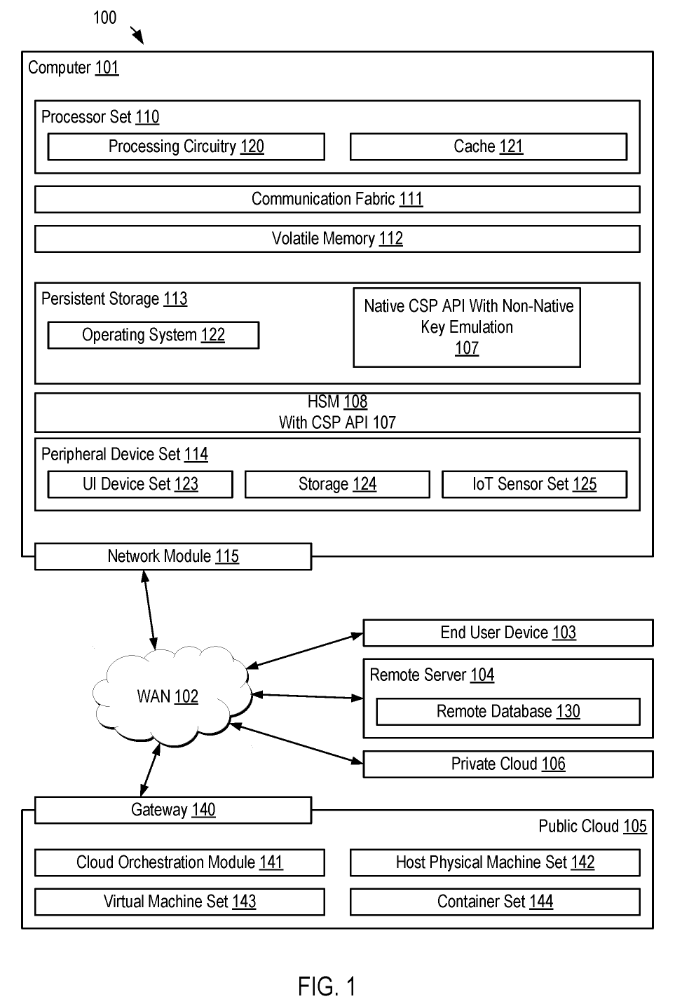

With reference now to FIG. 1, FIG. 1 sets forth an example of a computing environment according to aspects of the present disclosure. Computing environment 100 contains an example of an environment for the execution of at least some of the computer code involved in performing the various methods described herein, such as a native CSP API with non-native key emulation 107. The native CSP API with non-native key emulation 107 parses the full cryptographic key token into a functional key object and a non-functional metadata object. The native CSP API cryptographically links the functional key object and the non-functional metadata object to form a linked object pair representing the full cryptographic key token. The non-functional metadata object contains, for example, human readable data that is inert to the native CSP API. In response to a CSP API call from an application, the native CSP API generates an updated cryptographically linked object pair by updating at least one of either the cryptographically linked functional key object or the non-functional metadata object of the linked object pair. The native CSP API exports a fully formed modified cryptographic key token based on the updated cryptographically linked object pair. In another embodiment, the computing environment 100 includes a hardware security module (HSM) 108 with the CSP API with non-native key emulation 107 implemented as a processor executing firmware.

In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

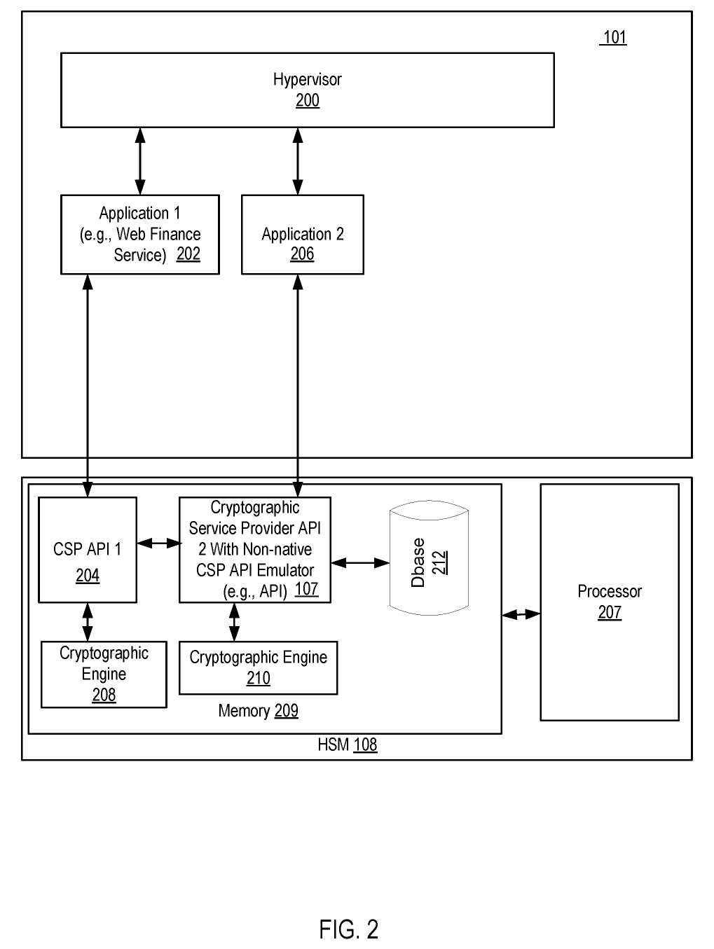

FIG. 2 illustrates a block diagram of a computer system, such as computer 101, with the CSP API with non-native key emulation 107 implemented in the HSM 108. However it will be recognized that the CSP API with non-native key emulation 107 may be implemented outside of an HSM if desired. The HSM includes a processor 207 and memory 209, that stores executable instructions that when executed operate as described below. The memory 209 also includes a database 212 that stores data objects and associated attributes including the functional key object and its associated attributes, and the non-functional metadata object and its associated attributes. In this example, the computer system includes the processor set 110 executing a hypervisor 200 that manages multiple executing applications with associated native CSP API’s. For example, application instance 202 uses a native CSP API 204 instance, and application 206 uses corresponding CSP API 107 instance. Each application has its own CSP API that is native for that given application. In this example, application 202 is a web finance application that uses a ANSI TR-31 key block standardized structure key format (e.g., an Atalla key block structure with key usage data) so that corresponding CSP API 204 also uses a cryptographic engine 208 and operations using the same ANSI TR-31 key block key format. Application 206 uses a different cryptographic key format, such as a PKCS11 standardized key format so that corresponding CSP API 107 uses a cryptographic engine 210 that uses the same PKCS11 key format. However, it will be recognized that a CSP may accommodate multiple types of key formats that are native to that CSP. In this example the CSP API 204 uses foreign or non-native key formats with respect to CSP API 107.

As further described below, the CSP API 107, among other operations, may be issued calls by the application 206 or other source to import a non-native full cryptographic key token from CSP API 204, perform operations with the key in the key token and then export the resulting key. As used herein a key token includes a key, associated key attributes and associated metadata such as data representing human readable information, such as key history information, key expiration data and other data. The key attributes may include data representing key restrictions such as whether the key can be used for other key algorithms beyond those initially designated, or any suitable restrictions. In some implementations, the CSP API 107 retains non-functional metadata objects, and retains the capability to recreate foreign objects' serialized forms through the lifecycle of the CSP API, unlike existing approaches. In some implementations, the CSP API 107 includes extensions to allow secure import and export of foreign keys. The CSP API 107, creates a functional key object and creates a corresponding linked non-functional metadata object from the non-native key token. This pairing of functional foreign key object and non-functional metadata objects allow transparent import and export of foreign keys through lifecycle paths, even if the underlying CSP API has essentially no understanding of the foreign attributes it manages.

For example, in some implementations, the CSP API 107 includes added call functionality to a 'native' generic CSP API, where functional keys, that are imported, and their external attributes needed only for interoperability are maintained as logically connected pairs of objects, by for example a cryptographical linking operation (e.g., through a hash operation, digital signing operation or other suitable operation). The logical pairing of a functional key and non-functional metadata is transparent to the rest of the CSP API, except for some key-transforming operations. The additional functionality to key-transforming operations allows seamless support of foreign keys (serialization formats), those not native to the CSP API 107. In some implementations, the CSP API 107 calls the cryptographic engine 210 to hash the non-functional metadata object (Hash(M)) and the CSP API 107 stores the hash of the non-functional metadata object (e.g., M1 or M1’ or M2) as an attribute in the functional key object, such that an attribute containing the Hash(M) is present in the functional key object This association or binding allows the services which are aware of the key object and metadata object pairs to verify that the two presented objects are indeed paired before they are used.

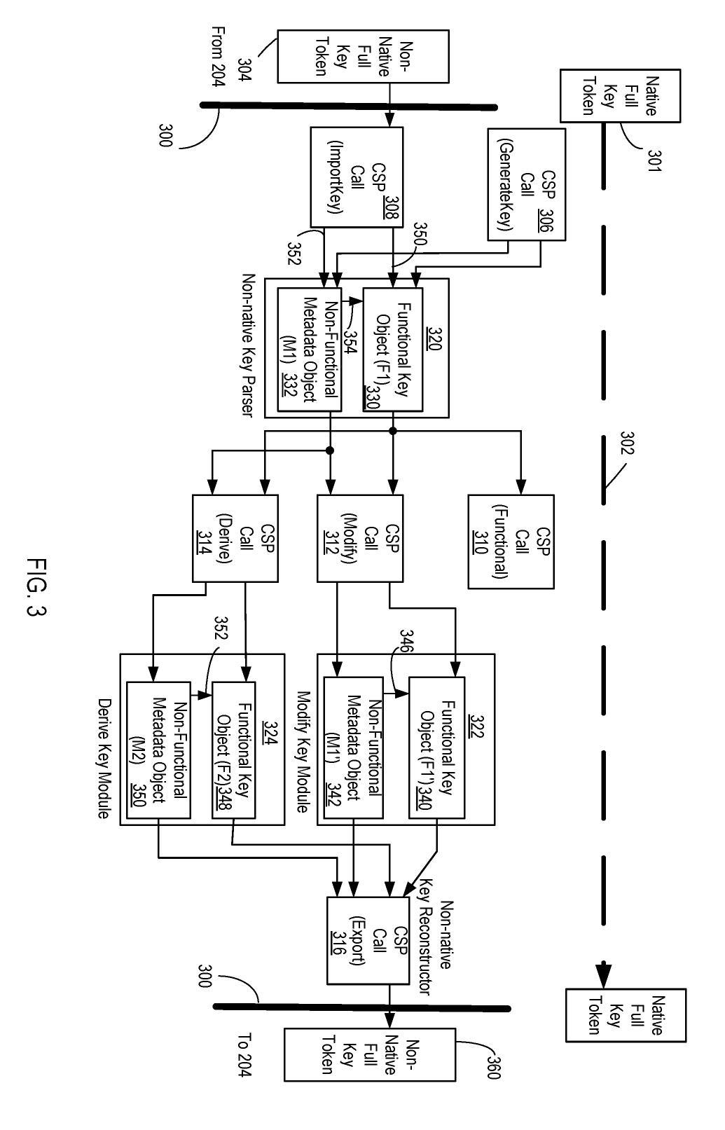

FIG. 3 sets forth a block diagram and operational flow of one example of the CSP API 107 with non-native key emulation 107 and native key management operations. The CSP API 107 is augmented with one or more extensions to carry all attributes of the non-native (foreign) CSP API 204, or equivalently, a foreign key/token format, using special, non-functional objects (metadata objects that include non-functional data). While these metadata objects are of no functional use for the native CSP API 107, they allow secure storage of all non-native API information associated with a non-native key. Raw keys of the foreign objects, and their usage restrictions which are understood by the native API, are imported to regular native-CSP objects.

API/file format emulation boundaries are shown by vertical lines 300. In this example, native key management operations are carried out as normally done with native full key tokens 301 as indicated by the dashed line 302. In this example, the CSP API 107 uses calls from one or more applications or other API's. In this example there is a generate key call 306, an import key call 308, a functional call 310, a modify key call 312, a derive key call 314 and an export key call 316. The export key call 316 operates as a non-native key reconstructor. Additional functionality is added to the import key call 308, the modify key call 312, the derive key call 314 and the export key call 316 for handling non-native full key tokens 304 as further described below. In some examples, extensions are added to the import key call 308, the modify key call 312, the derive key call 314 and the export key call 316 that implement the additional functionality. For example, the import key call 308, the modify key call 312, the derive key call 314 have a linking operation that cryptographically binds the functional key object and corresponding metadata key object that result from the called operation.

As illustrated in FIG. 3, the generate new key call 306 (GenerateKey()) or (GenerateKeyPair()), creates one or more objects corresponding to a newly generated key and in some implementations use only an CSP-internal random number generator for new keys. The call generates a new key or key pair and allows non-native metadata from a template or attribute supplied by the non-native CSP API for a new key. For example, for the generate key call 306, the call generates a new key, equipping it either with default metadata, or from attributes supplied to the GenerateKey(Pair)() call by the non-native API or calling application.

The CSP API 107 includes a non-native key parser 320, a modify key module 322 with functional key object and non-functional metadata object pair linking, and a derive key module 324 all with functional key object and non-functional metadata object pair linking. In response to an CSP API import call 308 the call unwraps the non-native full key token 304, the non-native key parser 320 parses, the full cryptographic key token from the non-native CSP API 204, and creates a functional key object 330 and a non-functional metadata object 332. The functional key object 330 includes the cryptographic key and corresponding key attributes from the full non-native key token. The non-functional metadata object includes data that is not necessary to provide functional operations using the key, such as to encrypt data, decrypt data, and cryptographically sign data. The non-functional data in one example is human readable data and is separated into another data object (non-functional metadata object) and cryptographically linked to the functional key object. For example, the non-functional metadata objects are restricted to be cryptographically inert and the parser removes all of the bits which would allow use in cryptographic 'functional' calls (such as bits which allow encryption/signing/etc.). In other words, while these metadata objects are recognized by the native CSP API, they reside in objects which are prohibited from any functional use. The bits within these non-functional objects include attributes used by the foreign formats for serialization, but are otherwise marked as being non-functional, by the removed bits, and are ignored by most of the native CSP API. Stated another way, when importing a foreign object, only a subset of its attributes have meaning for the native CSP API such as typical Boolean restrictions and most other attributes with no meaning for the native CSP API are ignored. The parser extracts any restriction understood by the native CSP API into the functional object F and retains other data to preserve foreign-object/API pedigree into the non-functional metadata M companion object.

The import call 308 imports an external key (UnwrapKey()). This function turns a wire-encoded key, not originating from the CSP API 107 itself, in a foreign/interchange format, into one or more objects that the CSP API 107 can directly utilize. In some implementations, import calls are the entry points for all objects which are not directly API-usable in their wire form by the native CSP API 107. The import call 308 reads a foreign key, returns a functional object, and a corresponding metadata object with non-functional data, as a multi-valued response. This is the call that deserializes foreign objects.

For functional calls 310, in one example, there are no changes to any attribute or in any object. In response to a call to perform a functional operation using the key and key attributes in the functional key object, the call 310 ignores the data in the non-functional metadata M to perform the functional operation. In some examples, the CSP API 107 calls make changes to key attributes in the functional key object in addition to changes to non-functional metadata attributes and other calls may only update key object attributes or metadata object attributes. However, in this example shown in FIG. 3 changes are made to both F1 and M1.

For example, the modify key call 312, in one example, updates both the functional key object and the non-functional metadata object. The functional key object F1 and the linked metadata object M1 also serve as an input for the call. For example, as part of the call operation, an attribute is changed for the functional key object F1 and/or the linked metadata object M1. For example, where key attributes in object F1 for the key in object F1 indicate that the key can only be used for a mode X and a mode Y, and the call sets a key attribute that also allows the key to be used for mode z (e.g., F1’ has more capabilities than F1), the F1’ object is changed to reflect the changed key attribute but is still linked to F1. In this example, the metadata history (human readable) noted that the key was not capable of using mode z is also updated with data to state that the key of F1’ is now also capable of using mode z.

The derive key call 314 derives F2 and M2 from F1, M1 by generating a new key based on one or more API-native keys (DeriveKey()). The call incorporates bits of the base key(s) into the resulting derived key. For the derive key call the integrity-checking operation is performed. For example, the CSP API identifies the original 'F' object, and ensures the call is also presented with the corresponding 'M' object, so the Hash(M) inside F matches the recomputed hash of the M object. A foreign-key-aware DeriveKey() call in some examples observes foreign-CSP restrictions (which are actually only in M, but not in the functional-object F). The reason such foreign restrictions are relevant is that many CSP APIs have their own knowledge about key hierarchies or key derivation---and therefore, restrictions on key derivation would be frequently encountered features to track across APIs.

In one example, the modify key call 312, as shown in FIG. 3, if needed, updates corresponding metadata. The modify key call advances F1 and M1 functional states to F1' and M1', respectively, through the SetAttribute(Value)() call. The metadata-identifying reference within the functional object is also updated. In one example, the modify key call 312 modifies attributes of a key, generally, excluding modification of the raw key bits, which is done by the derive key call.

Stated another way, functionality is added to several calls such that the code module 107 includes stored executable instructions that when executed by the processor perform additional services to handle foreign key objects. For example, for import calls 308 that import a foreign key token, the call parses foreign objects by separating raw keys and their CSP-observable usage restrictions (e.g., key attributes) to primary functional key objects, and creates corresponding non-functional metadata objects that store all other format-relevant non-functional data, such as human readable data, into the associated non-functional metadata objects. The CSP API 107 is aware of foreign-key serialization rules, to aid in the parsing.

For modify calls 312 which modify or derive calls 314 that derive keys, but not export them, the calls understand the internals of metadata objects to update them as well. These calls are therefore aware of metadata, but unlike import calls, they do not substantially interact with non-native keys' wire formats.

For export calls 316 which export native objects to non-native objects, the calls incorporate both code to verify functional key object and non-functional metadata object pairs' consistency, and serialization code to recreate foreign objects. The export key call 316 uses as input, the resulting functional key object and non-functional metadata object pairs from the respective modified key module 322 and derived key module 324 to reconstruct an updated non-native full key token for output back to the CSP API 204 or other suitable process. The export key call 316 exports an CSP API native key into a wire-encoded form, WrapKey(). This includes that the API-native input gets serialized into a 'foreign' form, which is useful for interoperability, but not direct functional use. The foreign form may support attributes which are of no relevance to the CSP API 107 itself. The CSP API 107 maintains non-functional metadata object (e.g., objects containing only non-functional data) for such serialize-to-foreign export calls. It is understood that interoperability additions needed to encode keys for other, foreign CSP APIs would need to be embedded in this call. For the export call, the call combines a functional key and its metadata from their respect objects to output foreign keys. This operation includes the integrity-checking prerequisite, and is the only one which needs to serialize foreign keys.

With these additions, as shown on FIG. 3 and described above, the extended CSP API 107 may fully transparently interface to foreign CSP APIs. Import-modify-export cycles are delimited by foreign-compatible serialized keys (tokens) both at ingress and egress, while native- CSP API functional calls 310 need only the functional parts of functional key object/ non-functional metadata object pairs.

For functional cryptographic uses, the imported functional objects are usable just as native-only keys are. Other than the extended metadata-associating attributes, for cryptographic-call purposes the functional keys work just as native-only ones would. In other words, functional-only imported keys work just as native ones of the same type/size/etc. The additional expanded CSP API services are opaque to "functional calls" of the CSP API---those which only provide cryptographic primitives. From the native CSP API’s perspective, the non-functional metadata object includes key attributes also used as a “key object” with nothing enabled. For the key lifecycle of import, transformation and export, the CSP API 107 maintains non-functional metadata objects along with corresponding functional key object as modifications are made to the keys and key attributes.

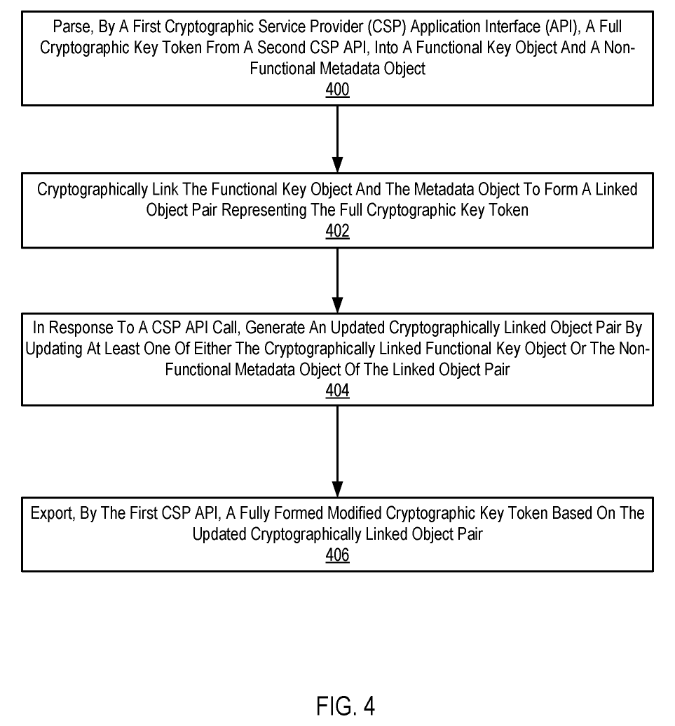

Referring also to FIG. 4, a flowchart of a computer implemented method is illustrated for emulating a foreign key using the native CSP API with non-native key emulation 107 structure shown in FIG. 3. For example, as shown in block 400 in response to an import call 308, the method includes parsing, by a first CSP API, such as native CSP API 107 using the non-native key parser 320, the full cryptographic key token 304 from a second CSP API, such as non-native CSP API 204. The import call 308 has as input, the non-native full key token 304 and performs an unwrapping of the non-native key token resulting in functional key output data 350 and corresponding auxiliary data, also referred to as metadata 352. The native CSP API 107 parses the full cryptographic key token into a functional key object and a non-functional metadata object by creating the functional key object 330 and the non-functional metadata object 332. For example, the parser 320 creates the functional key object 330 to include a key and key attributes obtained from the full cryptographic key token and creates the non-functional metadata object 332 to include CSP API inert data obtained from the full cryptographic key token, such as human readable data that is not needed when performing cryptographic operations with the key during functional key operations, such as encrypting, decrypting, digital signing operations using the key, within the CSP API life cycle.

As shown in block 402, the native CSP API, uses the parser 320 to cryptographically link, such as by using a hash operation shown by arrow 354, the functional key object 330 to the non-functional metadata object 332 to form a linked object pair F1, M1 representing the full cryptographic key token. The linked object pair can be considered by the CSP API 107 as a “virtual pair of keys” even though there are no keys in the non-functional metadata object.

In one example, the parser 320 creates the non-functional metadata object 332 containing, for example, only human readable data or other data from the non-native full key token that is inert to the native CSP API. As shown in block 404, in response to a CSP API call from an application, such as the modify call 312 and the derive key call 314, the native CSP API generates an updated cryptographically linked object pair F1’,M1’ or F2,M2 from the object pair F1, M1. For example, for the modify call 312 uses the modify key module 322 to update at least one of either the cryptographically linked functional key object F1 or the non-functional metadata object M1 of the linked object pair, which serve as inputs for the call 312 from the parser 320. The modify call and the derive key call may cause changes to data in both object types and the updated cryptographically linked object pair is generated using a CSP API call that changes a key attribute of the functional key object and changes the data of the non-functional metadata object. The resulting updated cryptographically linked object pair is formed by cryptographically binding the updated functional key object with the updated non-functional metadata object. For example, where a key attribute is modified by the call, the updated functional key object F1’ 340 results and where non-functional metadata is updated by the call, the updated non-functional metadata object M1’ 342 results. The updated object pairs 340 and 342 are cryptographically linked by a hash operation shown as arrow 346 to form object pair F1’,M1’. For example, the non-functional metadata object M1’ is hashed and either stored as an attribute in object F1’ or an attribute in object F1’ is updated.

Similarly, for a derive key call 314, generating the updated cryptographically linked object pair F2, M2 includes using a CSP API call, such as the derive key call 314 that generates a functional key object 348 that includes a derived key from the key in the functional key object F1 330 and that changes data in a corresponding bound non-functional metadata object M1 to create a corresponding updated non-functional metadata object 350 and uses the derive key module 324 to cryptographically bind the functional key object 348 with the non-functional metadata object 350 using a same hash and linking technique used by the import key call and the modify key call. In this example the functional key object 348 also includes key attributes for the derived key that are based on the key attributes from the functional key object 330.

As shown in block 406, in response to an export key call 316, the native CSP API 107 exports a fully formed modified cryptographic key token 360 based on either the updated cryptographically linked object pair 340, 342 or the cryptographically linked object pair 348, 350. In one example as part of the export operation, the call 316 operates as a non-native key reconstructor and reconstructs a non-native full key token 360 from the relevant object pairs F1’M1’ or M2, F2 and performs a key wrap operation that formats the data from object pairs into the format expected by the second CSP API, such as CSP API 204. In this example, exporting the fully formed foreign cryptographic key token 360 includes identifying one of a plurality of updated cryptographically linked object pairs that corresponds to the full cryptographic key token, and cryptographically wrapping the identified updated cryptographically linked object pair to form the fully formed foreign cryptographic key token. The final, foreign-format form of keys is reconstructed by an export call, also referred to as a final key-serialization call. This call combines raw key material from the primary key and any foreign-relevant metadata from the corresponding metadata object---if they indeed correspond to each other.

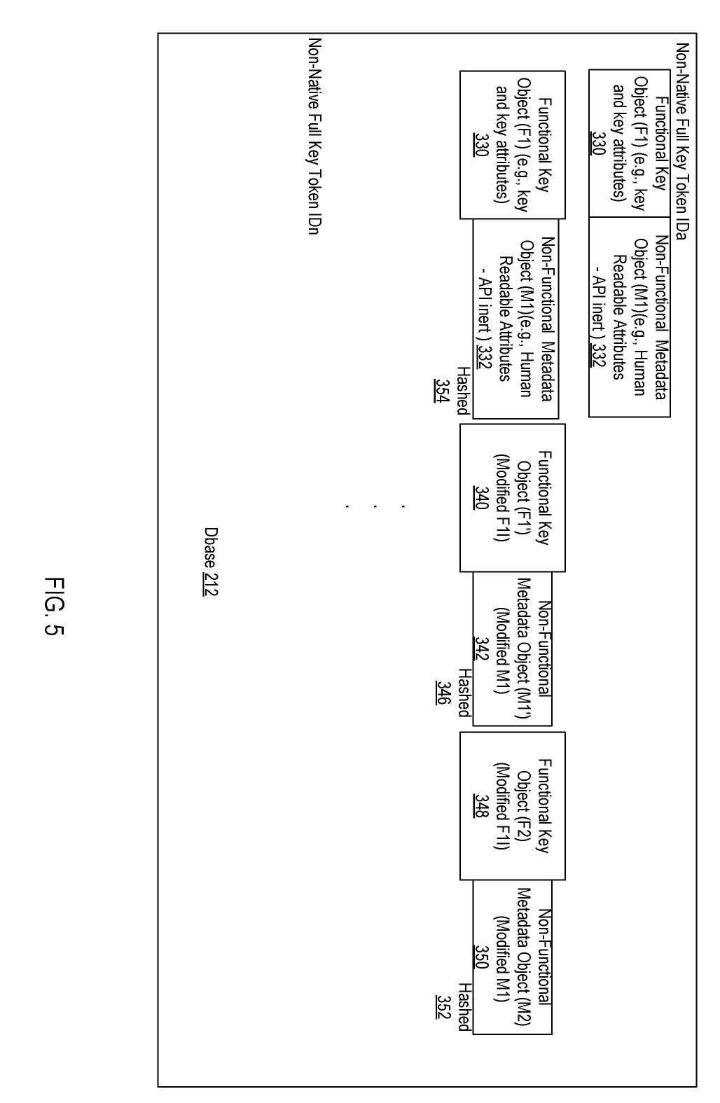

FIG. 5 sets forth a diagram illustrating bound non-native functional key object and associated non-functional metadata object pairs stored in memory, such as database 212 according to aspects of the present disclosure. For example, the parser links F1 and M1 by performing a hash operation on the non-functional metadata object M1 and stores the resulting hash value as an attribute in the functional key object F1 thereby marking an attribute in F1. In one implementation, if an object pair is to be updated, the call, such as the modify key call or the derive key call, employs a hash operation to recalculate the hash of the updated non-functional metadata object (e.g., in M' or M2), and marks the updated hash (M' or M2) in the attribute of the corresponding functional object (F' or F2) in the database.

For example, generating the updated cryptographically linked object pair of a particular imported non-native full key token, in response to the CSP API call includes generating a data object entry in database 212 that includes the updated cryptographically linked object pair F1’,M1’ and/or F2, M2 for each imported full key token. In this example data objects are stored as tuples for each imported full key token [TRUE?], however any suitable storage configuration and cryptographical linking operation may be employed.

State another way and again referring to FIGS. 3-5 The CSP API reads a key with foreign-supplied attributes, reads its corresponding non-functional metadata and ensures they are consistent. This is performed for an operation which needs to combine the two objects namely the modify, derive, and export calls. For example, a simultaneous use of F and M would first check that Hash(M) matches the present M.

The above calls can be implemented as extensions to standard calls, without introducing additional functions. For example, above mentioned new capabilities can be added to an existing CSP API, but do not require modifications to services which are unaware of metadata obtained from foreign keys.

In order to avoid adding security exposures around additional data imported into metadata (non-functional) objects, the non-functional metadata objects are cryptographically inert and rejected by functional API calls. This ensures that the auxiliary foreign data - those outside key types/restrictions/etc. supported by the native API, cannot be included as input of any of the native API calls. For example, the foreign or non-native non-functional metadata object contain human readable information such as labels and other non-cryptographic material.

As set forth above, the CSP API includes additions to 'native' CSP API calls which manipulate key objects - generate, import, modify, export - such that these points also accommodate non-functional metadata objects, associated with 'functional' key objects. These non-functional objects are indirectly, logically associated with their key objects, without impacting any of the rest of the API functionality. Details of non-functional objects' frames are determined by foreign formats, they represent any detail which a foreign-format key needs, but the native CSP API does not.

In some implementations, the CSP API extension treats two native-CSP objects, the functional key object and its non-functional metadata object, as a logical pair of keys. While they represent two regular API-managed objects, calls related to import/export or modification act on pairs as a single unit. In some implementations, key objects and their associated metadata objects are updated in an atomic operation, as a single unit. If an object (pair) is to be updated, the call employs a hash operation to recalculate the hash of the updated metadata object (e.g., in M'), and marks the updated hash(M') in the attribute of the functional object (F') in the database. This prevents an attack from taking a past, valid M object, and presenting the updated functional F' with the past-valid M.

In some implementations, a type identifier referred to as foreign (key) type identifier, documents the type of foreign object which has been imported to an API-native key; and a metadata identifier, marks which metadata object belongs to a particular key. A cryptographic hash is suitable for this feature. The metadata identifier allows unambiguous cross-checking of metadata vs. key integrity, when the pair is to be used as a single, multi-element tuple. In some implementations, the foreign key type identifier and metadata identifier may be added without interfering with the rest of API calls.

Associated metadata objects are 'cryptographically inert' and are marked not to allow any use by functional CSP calls. In other words, while these non-functional objects are API-readable and require no infrastructure additions, they may not be misused by functional calls. Calls which modify objects for example: SetAttibuteValue()], are adapted to tolerate an additional parameter. In addition to keys, each modification call updates the corresponding metadata, and also the key to reference the latter. Except for the additional functionality unique to dealing with foreign objects, native-only calls to the API are unchanged, the disclosed additions can be deployed without impacting any existing native code. As a consequence of storing non-functional metadata objects as 'cryptographically inert', foreign metadata which is not germane to core functionality may not be misused by API calls which are unaware of the nature of foreign-derived extensions. This restriction is added to ensure that none of the API-foreign metadata may bypass any (foreign) usage restrictions the native API is unaware of. Reading and writing pairs of objects---instead of single-valued parameters of the original native API, and using atomic updates, amount to single API calls with multi-valued inputs and outputs. In some implementations, the augmented calls, which accept and return two objects each, can be added to the native API transparently.

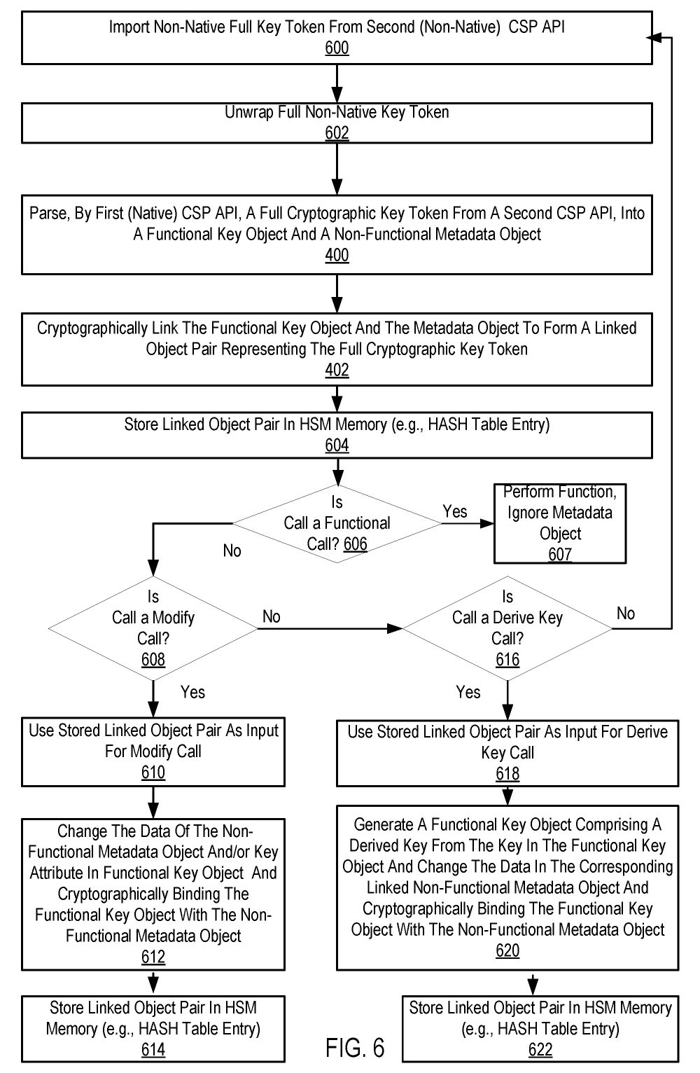

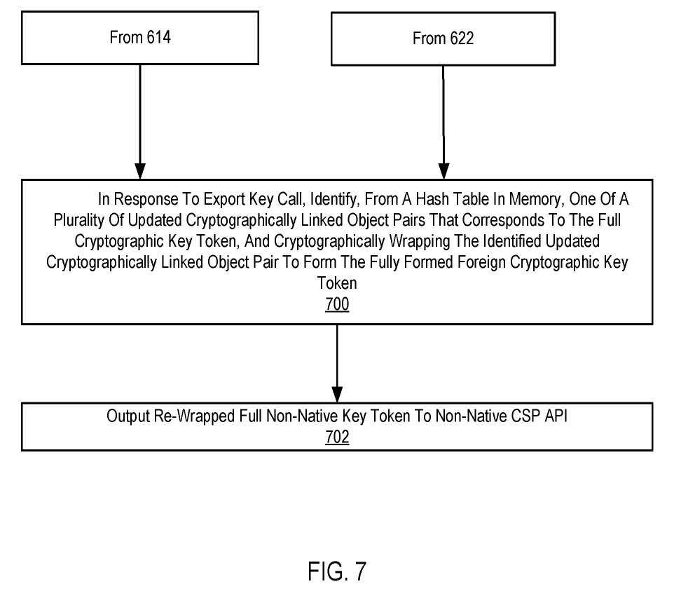

Referring also to FIGS. 6 and 7, another example of a computer implemented method is shown that is carried out by a processor executing the CSP API 107. As shown in block 600 the method includes importing the non-native full key token from the non-native CSP API 204, such as by using the import call 308. As shown in block 602 the method includes unwrapping the full non-native key token, such as by using the import call 308 and producing functional key output such as the key and key attributes (e.g., key restriction information) from the full key token 304 and auxiliary output, such as data corresponding to human readable data or other data that does not affect functional use of the key during key use by the CSP API 107, which is the metadata that is included in the non-functional metadata object 332 . Unwrapping is done using know cryptographic techniques. As shown in block 400, the import call 308 also invokes the non-native key parser 320 that parses the full cryptographic key token from the non-native CSP API, into the functional key object and the non-functional metadata object. The functional key object and the non-functional metadata object (e.g., F1, M1) are stored in memory and in one example, are indexed by a full key token identifier (see e.g., FIG. 5). As shown in block 402, in this example, the parser 320 cryptographically links, such as by performing a hash operation on the non-functional metadata object M1 and links it to the functional key object F1 to form a linked object pair representing the full cryptographic key token 304. As shown in block 604, the parser stores the linked object pair F1,M1 in memory as a tuple in the database. In some implementations, the linked object pair is stored in HSM memory. In other implementations the linked object pair may be stored in memory external to the HSM that is secure. For example, stateless HSMs, where each call gets a newly generated object or set of objects, the storage is external to the HSM.

As shown in block 606, if the call is a functional key call 310 for a functional operation using the key, such as a call to encrypt data with the key, decrypt data or use the key from F1 to perform other cryptographic operations, as shown in block 607 the CSP API performs the functional call and there is no change to the attributes in either the functional key object to the non-functional metadata object. The functional call 310 does not use the non-functional metadata object as input.

As shown in block 608, when the call is a modify call 312, the modify call uses the modify key module to use stored linked object pair F1, M1 stored by the parser as input for the modify call as shown in block 610. As shown in block 612, the modify key module changes the data of the non-functional metadata object and/or key attribute in functional key object and creates updated object F1’ and/or M1’ and cryptographically binds the updated functional key object F1’ with the non-functional metadata object M1’ using the same hash operation as the parser if desired. As shown in block 614, the modify key module stores the linked object pair F1’,M1’ in HSM memory as part of a tuple in a hash table as illustrated in FIG. 5.

Referring back to block 608, if the call is a derive key call 314, as shown in block 616, the method includes using the stored linked object pair F1,F2 from the parser as input as shown in block 618. As shown in block 620, the method includes generating a functional key object F2 that include a derived key from the key in the functional key object F1 and changing the data in the corresponding linked non-functional metadata object M2 and cryptographically binding the functional key object F2 with the non-functional metadata object M2, using the same hash function as used for binding the other object pairs. In this example this is done by the derive key module. As shown in block 622, the derive key module stores the linked object pair F2,M2 in HSM memory as part of a tuple in a hash table as illustrated in FIG. 5.

As shown in block 700 in FIG. 7, the method includes in response to an export key call 316, the call performs non-native key reconstruction and identifies, from the hash table in memory, one of a plurality of updated cryptographically linked object pairs that corresponds to the full cryptographic key token, such as searching the full token key identifier in the table that was including in the export call and cryptographically re-wraps the identified updated cryptographically linked object pair to form the fully formed foreign cryptographic key token 360. The export call is aware of both native and foreign objects and interrogates both F and M, and reassembles them into the foreign-API export version. What to reassemble is inferred from the (F, M) tuple. For example, generic information such as "RSA key" would be implied from the F main object; any API-specific decorator or RSA-specific restricted type would be inferred from M (if the foreign API, as an example, uses different object IDs for RSA keys of different targeted usage). As shown in block 702, the export key call 316 outputs the re-wrapped non-native full key token 360 to the non-native API 204, to memory for use by other processes or to another requesting API.

As set forth herein, a native Cryptographic Service Provider (CSP) Application Programming Interface (API) is enhanced with one or more call extensions that enables import management and export of foreign cryptographic keys and associated metadata. In some implementations, unlike conventional systems that discard non-functional metadata, the CSP API emulates certain key management operations for non-native key formats and employs a non-functional metadata object that is linked to a corresponding functional key object and records changes to attributes of either or both the non-functional key metadata object and the functional key object as key operations for non-native keys tokens are performed under control of the CSP API. The resulting fully compliant exported key token includes the native key (and any changed attributes) and non-functional metadata from the non-functional meta data object, such as human readable metadata, that was updated during the emulation (which includes additional attributes and/or changes to existing metadata attributes). In some examples, a proprietary attribute identifying non-functional metadata object M1 is linked with a key object F1.

The parser unwraps the incoming foreign key token and generates a functional key object, F1 which is an object that includes the cryptographic key in the incoming foreign key token along with data representing associated key attributes that identify operational restrictions for the key such as whether the key can be a parent key, can be used to encrypt and/or decrypt, can or cannot be exported and other operational restrictions. The parser generates a metadata object, M1, that contains “API inert” data from the unwrapped foreign key token. For example, the metadata object contains human readable data from the unwrapped foreign key token, such as key labels, certificates, key expiration data and other non-functional information that is “API inert” meaning that it does not impact key functions within the CSP API.

The foreign key reconstructor puts the information into the non-native full key token format and cryptographically re-wraps the key and metadata information to form a fully formed key token that in the same format as the incoming key token. The re-wrapped fully formed modified key token is sent to the host, non-native CSP API or other service that requested the key.

As set forth above, the CSP API works on the bound pair of objects unlike conventional systems that only work on the single functional key block when processing foreign key token. In some implementations, no new calls are added to the CSP API but calls are expanded with new capabilities that provide foreign key metadata linking to existing calls, such as import, modify and derive calls so that the flows are the same with CSP API calls for native keys and foreign keys and their restrictions (e.g., attributes). In some implementations, the native cryptographic service provider application interface includes a call operative to activate a key management service that is operative to change restrictions on an object associated with a foreign key token including changing key attributes in a functional key object, and/or update metadata in a non-functional metadata object based on the changes, such as changing a history of an object that was initially restricted to not leave the CSP API.

In some implementations, the CSP API creates a modified key by the native CSP API based on the foreign functional cryptographic key, creates modified external metadata and cryptographically links the modified key and the modified external metadata and stores the cryptographically linked modified key and the modified external metadata in a database in the HSM. In some implementations, the CSP API updates both the functional key object and the non-functional metadata object at same time when changes to one require changes to the other.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
parsing, by a first cryptographic service provider (CSP) application interface (API), a full cryptographic key token from a second CSP API, into a functional key object and a non-functional metadata object;
cryptographically linking the functional key object and the non-functional metadata object to form a linked object pair representing the full cryptographic key token;
in response to a CSP API call, generating an updated cryptographically linked object pair by updating at least one of either the cryptographically linked functional key object or the non-functional metadata object of the linked object pair; and
exporting, by the first CSP API, a fully formed modified cryptographic key token based on the updated cryptographically linked object pair.

2. The computer-implemented method of claim 1, wherein parsing the full cryptographic key token comprises creating the functional key object to comprise a key and key attributes obtained from the full cryptographic key token and creating the non-functional metadata object to comprise CSP API inert data obtained from the full cryptographic key token.

3. The computer-implemented method of claim 2, wherein generating the updated cryptographically linked object pair comprises using a CSP API call that changes a key attribute of the functional key object and changes the data of the non-functional metadata object, and cryptographically binding the functional key object with the non-functional metadata object.

4. The computer-implemented method of claim 2, wherein generating the updated cryptographically linked object pair comprises using a CSP API call that generates a functional key object comprising a derived key from the key in the functional key object and that changes data in a corresponding bound non-functional metadata object and cryptographically binding the functional key object with the non-functional metadata object.

5. The computer-implemented method of claim 1, wherein generating the updated cryptographically linked object pair in response to the CSP API call comprises generating a data object entry in memory that comprises the updated cryptographically linked object pair.

6. The computer-implemented method of claim 5, wherein exporting, by the first CSP API, the fully formed modified cryptographic key token comprises identifying one of a plurality of updated cryptographically linked object pairs that corresponds to the full cryptographic key token, and cryptographically wrapping the identified updated cryptographically linked object pair to form the fully formed foreign cryptographic key token.

7. The computer-implemented method of claim 2, wherein in response to a call to perform a functional operation using the key and key attributes in the functional key object, ignoring the data in the non-functional metadata object to perform the functional operation.

8. A computer system comprising:
one or more processors;
one or more computer-readable storage media; and
program instructions stored on the one or more storage media to cause the one or more processors to perform operations comprising:
parsing, by a first cryptographic service provider (CSP) application interface (API), a full cryptographic key token from a second CSP API, into a functional key object and a non-functional metadata object;
cryptographically linking the functional key object and the non-functional metadata object to form a linked object pair representing the full cryptographic key token;
in response to a CSP API call, generating an updated cryptographically linked object pair by updating at least one of either the cryptographically linked functional key object or the non-functional metadata object of the linked object pair; and
exporting, by the first CSP API, a fully formed modified cryptographic key token based on the updated cryptographically linked object pair.

9. The computer system of claim 8, comprising a hardware security module (HSM) that comprises the one or more processors and the one or more computer-readable storage media and wherein the program instruction cause the one or more processors to store the linked object pair representing the full cryptographic key token and the updated cryptographically linked object pair in the one or more computer-readable storage media in the HSM.

10. The computer system of claim 8, wherein the program instructions stored on the one or more storage media to cause the one or more processors to generate the updated cryptographically linked object pair using a CSP API call that changes a key attribute of the functional key object and changes data of the non-functional metadata object, and cryptographically binds the functional key object with the non-functional metadata object.

11. The computer system of claim 8, wherein the program instructions stored on the one or more storage media to cause the one or more processors to parse the full cryptographic key token by creating the functional key object to comprise a key and key attributes obtained from the full cryptographic key token and creating the non-functional metadata object to comprise CSP API inert data obtained from the full cryptographic key token.

12. The computer system of claim 8, wherein the program instructions stored on the one or more storage media to cause the one or more processors to generate the updated cryptographically linked object pair using a CSP API call that generates a functional key object comprising a derived key from the key in the functional key object and changes data in a corresponding bound non-functional metadata object and cryptographically binds the functional key object with the non-functional metadata object.

13. The computer system of claim 8, wherein the program instructions stored on the one or more storage media to cause the one or more processors to generate the updated cryptographically linked object pair in response to the CSP API call by generating a data object entry in memory that comprises the updated cryptographically linked object pair.

14. The computer system of claim 8, wherein the program instructions stored on the one or more storage media to cause the one or more processors to export, by the first CSP API, the fully formed modified cryptographic key token by identifying one of a plurality of updated cryptographically linked object pairs that corresponds to the full cryptographic key token, and cryptographically wrapping the identified updated cryptographically linked object pair to form the fully formed modified cryptographic key token.

15. The computer system of claim 11, wherein the program instructions stored on the one or more storage media to cause the one or more processors to, in response to a call to perform a functional operation, use the key and key attributes in the functional key object, ignore the data in the non-functional metadata to perform the functional operation.

16. A computer program product comprising:
one or more computer-readable storage media; and
program instructions stored on the one or more storage media to perform operations comprising:
parsing, by a first cryptographic service provider (CSP) application interface (API), a full cryptographic key token from a second CSP API, into a functional key object and a non-functional metadata object;
cryptographically linking the functional key object and the metadata object to form a linked object pair representing the full cryptographic key token;
in response to a CSP API call, generating an updated cryptographically linked object pair by updating at least one of either the cryptographically linked functional key object or the non-functional metadata object of the linked object pair; and
exporting, by the first CSP API, a fully formed modified cryptographic key token based on the updated cryptographically linked object pair.

17. The computer program product of claim 16, wherein the one or more computer-readable storage media comprises program instructions stored therein to perform operations comprising generating the updated cryptographically linked object pair using a CSP API call that changes a key attribute of the functional key object and changes data of the non-functional metadata object, and cryptographically binds the functional key object with the non-functional metadata object.

18. The computer program product of claim 16, wherein the one or more computer-readable storage media comprises program instructions stored therein to perform operations comprising parsing the full cryptographic key token by creating the functional key object to comprise a key and key attributes obtained from the full cryptographic key token and creating the non-functional metadata object to comprise CSP API inert data obtained from the full cryptographic key token.

19. The computer program product of claim 16, wherein the one or more computer-readable storage media comprises program instructions stored therein to perform operations comprising generating the updated cryptographically linked object pair using a CSP API call that generates a functional key object comprising a derived key from the key in the functional key object and changes data in a corresponding bound non-functional metadata object and cryptographically binds the functional key object with the non-functional metadata object.

20. The computer program product of claim 16, wherein the one or more computer-readable storage media comprises program instructions stored therein to perform operations comprising causing to export, by the first CSP API, the fully formed modified cryptographic key token by identifying one of a plurality of updated cryptographically linked object pairs that corresponds to the full cryptographic key token, and cryptographically wrapping the identified updated cryptographically linked object pair to form the fully formed modified cryptographic key token.
